(19) United States
(12) Patent Application Publication
(10) Pub. No.: US 2013/0254987 A1
(43) Pub. Date: Oct. 3, 2013

(54) WAIST TRANSFER BELT

(71) Applicant: Åsa Brännström, Lulea (SE)

(72) Inventor: Åsa Brännström, Lulea (SE)

(73) Assignee: HANDICARE AB, Jarfalla (SE)

(21) Appl. No.: 13/820,345

(22) PCT Filed: Sep. 2, 2011
(86) PCT No.: PCT/SE2011/051061

§ 371 Date: Jun. 19, 2013

(30) Foreign Application Priority Data
Sep. 3, 2010 (SE) 1050909-9

(51) Int. Cl. A61G 7/10

(52) U.S. Cl. CPC A61G 7/1023
USPC 5/81.1 T

(57) ABSTRACT

A transfer belt (1) for facilitating assisted transfer of a person, said transfer belt comprising a belt body (2); a loop (6A; 6D, 6E, 6F; 6G) being attached to the belt body at a first longitudinal position (8A; 8D; 8E, 8F; 8G) in a longitudinal direction of said belt body; and handle means (5A-C, 5A′; 5C′) being slidably arranged through said loop (6A; 6D, 6E, 6F; 6G), said handle means being attached to the belt body (2) at a second longitudinal position (8B) in said longitudinal direction, wherein said second longitudinal position being, in said longitudinal direction, spaced apart from said first longitudinal position such that, when subjecting said handle means to an external force, the handle means is forced through the loop thereby longitudinally forcing the first and second longitudinal positions together in order to tighten the transfer belt (1) against the waist of said person.

### TECHNICAL FIELD OF THE INVENTION

The invention relates to the field of transfer belts used for facilitating assisted transfer of a person wearing the transfer belt around the waist. More particularly, the invention relates to a transfer belt with a tightening property.

### TECHNICAL BACKGROUND

There exists a wide range of various transfer belts and harnesses for various transfer situations, such as lifting, walking or combinations thereof. These transfer aids are attached to a person who needs assistance or help during the transfer, such as patients, elderly or invalid persons or other persons in need of assistance during a specific transfer situation, e.g. help raising the person from a seated to a standing position. Other transfer situations are, for example, lifting a person or supporting the person during walking or a standing position or in any position where the assisted person needs support.

Depending on the type of transfer belt and if the person is active or passive during the transfer, i.e. an active or passive transfer belt, the transfer belt may be attached and secured to the person in many ways. In case of an active transfer belt, i.e. the case where the patient is active, one way to attach the transfer belt is around the waist of the person. The active transfer belt is thereafter ready to be used as an aid to transfer the person who needs assistance. During an active transfer operation, one or more assisting persons applies a pulling, raising or supporting force to the transfer belt via a handle or handles attached to the belt. Thus, the assisting person(s) grasps the handle or handles and performs a transfer operation by applying an external force via the handle and belt to the waist of the assisted person, thereby achieving an assisted transfer of the person. Although the example above describes a force transmission situation where the external force is applied to the belt by means of other persons, i.e. by hand, it is understood that the external force may be applied by means of a raising or pulling device which is connected to the belt, either to the handle or another connection point.

Furthermore, transfer belts may also comprise fastening means to fasten the belt around the waist of the assisted person. However, such a transfer belt may need to be attached sufficiently tight to the waist in order to avoid that the belt moves or slides relative to the waist of the person during a transfer. Such unwanted relative movement deteriorates the force transmission to the assisted person, i.e. the external force is indirectly and imprecisely transmitted to the assisted person. Furthermore, such relative movement, i.e. the sliding of the belt, is also uncomfortable for the person wearing the belt during, for example, a raising operation.

### SUMMARY OF THE INVENTION

It is an object of the present invention to provide an improved transfer belt which, during the transfer operation, reduces relative movement between the transfer belt and the waist of the person wearing the belt without reducing the degree of comfort of the person wearing the transfer belt.

This and other objects are achieved according to the present invention by providing a transfer belt having the features defined in the independent claim. Preferred embodiments are defined in the dependent claims.

According to the invention, there is provided a transfer belt for facilitating assisted transfer of a person in need of assisted transfer. The transfer belt comprises a belt body, a loop and a handle means, wherein the handle means is slidably arranged through the loop. The loop is attached to the belt body at a first longitudinal position in a longitudinal direction of the belt body. The handle means is attached to the belt body at a second longitudinal position in said longitudinal direction, wherein said second longitudinal position is, in said longitudinal direction, spaced apart from said first longitudinal position such that, when subjecting said handle means to an external force, the handle means is forced through the loop thereby longitudinally forcing the first and second longitudinal positions of the belt body together in order to tighten the transfer belt against the waist of said person. Put differently, the loop and the handle means are attached to the belt body at a first and second attachment points which are spaced apart from each other by means of a tightening length in the longitudinal direction of the belt body, i.e. in the direction of the length of the transfer belt. Thus, the first and second attachment points of the loop and the handle means are arranged at different longitudinal positions along the transfer belt, i.e. at different longitudinal positions along the encircled waist of the person when the belt is fitted thereto. As mentioned above, the handle means is subjected to an external raising, pulling or supporting force which is a force that tension the handle means thereby longitudinally forcing together the second attachment point, where the handle means is attached to the belt body, and the first attachment point where the loop, through which the handle means is slidable.

Thus, the present invention is based on the insight that by allowing the handle means to slidably pass through at least one loop, the handle means provides both a handle function and a tightening function for tightening the transfer belt. Consequently, the handle means serves both as a handle and a tightening means. When the handle means is subjected to an external force, the handle means is slidable through the loop in order to force the first longitudinal position, i.e. the first attachment point of the belt body towards the second longitudinal position, i.e. the second attachment point of the belt body, and thereby obtaining a tightening effect of the transfer belt. Thus, apart from providing a handle function, the handle means in combination with the loop provides a tightening function. In detail, a first end of the handle means is attached to the belt body at the second longitudinal position and the handle means thereafter slidably passes through the loop that is attached to the belt body at the first longitudinal position, whereas the handle means at the other side of the loop at a second end of the handle means, opposite to the first end, may be subjected to an external force to pull or force through the loop that part of the handle means that extends between the second longitudinal position and the first longitudinal position, i.e. the tightening length. Since the tightening length is shortened the circumference of the belt body and the transfer belt is reduced which thereby tightens or radially forces the belt body and the transfer belt against the waist of the person wearing it. Consequently, a tightening effect is obtained while maintaining a high degree of comfort, both during a transfer operation and when the person is not subjected to a transfer operation.

It is understood that the magnitude of the tightening effect may be varied by varying the length of tightening length. For example, if an upper limit in tightening effect is wanted then the tightening length should be short such that the first and second longitudinal positions can meet at only a small amount of force. The opposite is also achievable, if the tightening length is large enough then the first and second longitudinal positions will never meet, i.e. without any upper limit in the tightening effect. However, it is also understood that the tightening effect depends on the circumference of the waist of the person wearing the transfer belt.

It is understood that the term “longitudinal direction” refers to the direction of the length of the transfer belt, i.e. the length that encircles the waist of person wearing the belt. Furthermore, it is further understood that the term “longitudinal position” refers to a position in the longitudinal direction, i.e. along the transfer belt.

In an embodiment the transfer belt further comprises at least one additional loop which is attached to the belt body at at least one additional first longitudinal position in the longitudinal direction of said belt body; and at least one additional handle means, wherein said at least one additional handle means being slidably arranged through said at least one additional loop, wherein said at least one additional handle means is attached to the belt body at at least one additional second longitudinal position in said longitudinal direction, wherein said at least one additional second longitudinal position(s) is, in said longitudinal direction, spaced apart from said at least one additional first longitudinal position such that, when subjecting said at least one handle means to an external force, the at least one additional handle means is forced through the at least one additional loop thereby longitudinally forcing the at least one additional first and second longitudinal positions together in order to tighten the transfer belt against the waist of said person. Thus, according to the invention there is provided a transfer belt for facilitating assisted transfer thereof, wherein the transfer belt comprises a belt body; at least one loop which is/are attached to a belt body at at least one loop position; and at least one handle means which is/are slidably arranged through the at least one loop, wherein the at least one handle means is/are attached to the belt body at at least one handle means position, and wherein the at least one handle means position is spaced apart or different from the at least one loop position in a longitudinal direction of the transfer belt such that the handle means is forced through the loop when the handle means is subjected to an external force, thereby longitudinally forcing at least one of said loop positions and at least one of said handle means position together in order to tighten the transfer belt against the waist of said person.

Put differently, the transfer belt comprises a belt body and thereto attached at least one tightening arrangement for tightening the belt body around a person for facilitating assisted transfer thereof, wherein said tightening arrangement comprises at least one loop attached to the belt body at at least one loop position; and at least one handle means slidably arranged through said at least one loop, wherein the at least one handle means is attached to the belt body at at least one handle means position. The at least one handle means position is spaced apart or different from said at least one loop positions in a longitudinal direction of said belt such that, when subjecting said at least one handle means to an external force, the at least one handle means is forced through the at least one loop thereby longitudinally forcing at least one of said at least one loop position and at least one of said at least one handle means position together in order to tighten the transfer belt against the waist of said person. In an alternative embodiment, the transfer belt comprises different tightening arrangements with different tightening capabilities, the longitudinal distance between the loop position and the handle means position may be varied to obtain different tightening effects. Thus, the transfer belt may be provided with at least one tightening arrangement with different tightening length thereby obtaining a transfer belt with variable tightening effect

In an embodiment of the invention, the loop comprises a loop body having a first loop end and a second loop end. The first and second loop ends are attached to the belt body at the first longitudinal position such that the handle means passes through the loop essentially at the first longitudinal position. In other words, the loop body is attached to the belt body at the first loop end and the second loop end, and the loop body is loosely extending between the attachments at the belt body of the first loop end and the second loop end, thus forming a space between the loop body and the belt body, through which the handle means is slidably arranged. Because the loop body is attached to the belt body at the first loop end and the second loop end, movement of the handle means relative to the belt body in other directions than the longitudinal direction of the belt body is delimited by the attachments at the belt body of the first loop end and second loop end. Also, the force transmitted from the handle means, via loop body, to the belt body is distributed in an efficient manner due to the two attachments at the first loop end and second loop.

In another embodiment of the invention, the belt comprises handle means being attached to the belt body at a third longitudinal position, i.e. at third attachment point, that is spaced apart from the first longitudinal position, i.e. the first attachment point and the second longitudinal position, i.e. the second attachment point. Thus, the handle means forms a handle which is attached to the belt body. Furthermore, the handle means may advantageously extend loosely between the attachments at the second longitudinal position and third longitudinal position. Thereby a gap is formed between the handle and the belt body which allows the handle to be easily grasped. The first longitudinal position may furthermore advantageously be located between the second longitudinal position and third longitudinal position in the longitudinal direction of the belt body. In other words, the handle means is at a first end thereof attached to the belt body at a second longitudinal position and is at a second end attached to the belt body at a third longitudinal position. The loop, through which the handle means is slidably arranged, is arranged between the second and third longitudinal positions in the longitudinal direction, i.e. the loop is located between the first and second ends of the handle means. Thus, two handles are defined by the belt body, the handle means and the loop, thereby resulting in one graspable handle at either side of the loop at the first longitudinal position.

In another embodiment of the invention, the belt comprises at least two loops which are attached to the belt body at longitudinal positions which are spaced apart from the second longitudinal position and third longitudinal position. The handle means is slidably arranged through said at least two loops. Thereby, more positions where external force can be transmitted to the handle means are obtained. Put differently, a more versatile transfer belt is achieved since more possibilities to grasp the transfer belt are available. The longitudinal positions of said at least two loops may advantageously be located between said second longitudinal position and third longitudinal position. In other words, the handle means is attached to the belt body at a second longitudinal position, thereafter passes through said at least two loops, through which the handle means is slidably arranged, which are also attached to the belt body and is finally attached to the belt body at the third longitudinal position. Thus, at least three easily graspable portions of the handle means are formed between the belt body, handle means and the loops resulting in at least three handles which allows that two person may simultaneously grasp the transfer belt which may achieve an accurate and safe transfer of the person in need of assistance.

Put differently, the transfer belt according to an embodiment further comprises at least one additional loop which is attached to the belt body at at least one longitudinal position in said longitudinal direction which is/are spaced apart from said second longitudinal position(s) and third longitudinal position(s), wherein said at least one additional handle means is slidably arranged through said at least one additional loop.

In yet another embodiment of the present invention, the loops are evenly distributed over the longitudinal length of the belt body. Consequently, when the handle means is subjected to an external force, the force from the handle means belt is evenly distributed to the transfer belt thereby achieving a uniform tightening around the waist of the person wearing the belt, providing a comfortable transfer operation.

In yet another embodiment of the present invention, the transfer belt further comprises cushioning means at an inner surface facing said person wearing it. Thus, a transfer belt which is comfortable for the person wearing it is achieved.

In yet another embodiment of the present invention, the transfer belt comprises handle means and loop(s) which are attached to an outer surface of the transfer belt facing away from said person wearing it. In other words, when the person wears the transfer belt, handle means and loop(s) are arranged on the outside of the belt, facing away from the waist of the person. Thus, handle means are easily grasped, allowing convenient use of the transfer belt.

In yet another embodiment of the present invention, the transfer belt further comprises fastening means for releaseably fastening said transfer belt around the waist of the person needing assisted transfer. Thus, the transfer belt can easily be attached and detached around the waist of the person.

In yet another embodiment of the present invention, the transfer belt comprises at least one stationary handle which is attached to the belt body. Thereby, more positions where external force can be transmitted to the transfer belt are achieved. Put differently, more possibilities to grasp the transfer belt are available. Also, during operation of the transfer belt when the belt has been tightened, it may be difficult to grasp the tightened handle mean. Thus, the transfer belt provides a handle function irrespective of the situation.

### BRIEF DESCRIPTION OF THE DRAWINGS

These and other aspects of the present invention will now be described in more detail, with reference to the appended drawing showing a currently preferred embodiment of the invention, wherein:

FIG. 1 is an illustration of a transfer belt in accordance with an embodiment of the invention.

FIG. 2a is an illustration of a transfer belt in accordance with an embodiment of the invention.

FIG. 2b is an illustration of a transfer belt in accordance with an embodiment of the invention.

FIG. 2c is an illustration of a transfer belt in accordance with an embodiment of the invention.

### DETAILED DESCRIPTION OF A PREFERRED EMBODIMENT OF THE INVENTION

In the following description, an embodiment of the present invention is described with reference to a transfer belt with multiple loops, multiple stationary handles, handle means attached at two longitudinal positions on the belt body and a buckle-type fastening means.

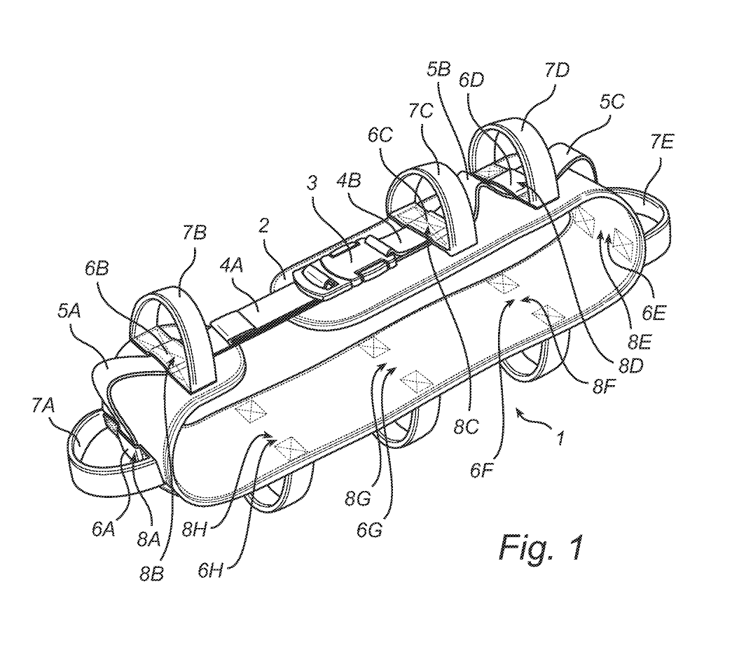

FIG. 1 illustrates a transfer belt 1 having a belt body 2 and fastening means. The fastening means is provided with a buckle 3 which is attached to the belt body via fastening straps 4A-B. These fastening straps are attached to the belt body at longitudinal positions 8B and 8C where stationary handles 7B and 7C are attached to the belt body. In this embodiment the belt body 2 has a length sufficient to essentially encircle the waist of a person (not shown) wearing the belt. The surface of the belt body 2 is covered with a durable material comprising nylon, and the edges are further tipped.

A number of stationary handles 7A-E are attached to an outer surface of the belt body 2, extending in a transversal direction, i.e. perpendicular to the longitudinal direction, of the belt body. The outer surface of the transfer belt in this context is the surface facing away from the person (not shown) wearing the belt. The stationary handles have curved shapes from the outer surface of the transfer belt providing graspable spaces defined by the belt body and the handle body.

The transfer belt is further provided with a handle means which is a strap 5 extending in the longitudinal direction. The strap is, at either ends of the strap, attached to the outer surface of the belt body 2 at longitudinal positions 8B and 8C at attachment points 6B and 6C, respectively. The strap extends in the longitudinal direction of the belt body along the center of the belt body. Furthermore, the strap 5 is slidably arranged through a number of loops 6A, 6D which are located at longitudinal positions 8A-H. Also, the strap extends loosely along the belt body thereby forming graspable handles 5A-C along the longitudinal direction of the transfer belt. In other embodiments, handle means may be a tape, line, rope, cord or a lace.

The loops are attached to the outer surface of the belt body 2 at the same longitudinal positions as those of the stationary handles. However, it is understood that the stationary handles may be arranged at longitudinal positions other than those of the loops, i.e. that the loops and the stationary handles are spaced apart from each other. In FIG. 1, all loops have a loop body that extends in the transversal direction of the belt body, and is attached to the belt body at either ends of the loop body. The loop bodies are in this embodiment straps. In other embodiments, the loop bodies may be tapes, lines, ropes, cords, bands or laces. Furthermore, the loop bodies may be made of a material suitable for providing a loop function, such as a plastic material, textile material, metallic material or woven fabric material. Thus, the tapes, lines, ropes, cords, bands or laces may be made in a plastic, textile, metallic, or woven fabric material.

The inner surface of the belt body 2, i.e. the surface facing the waist of the person wearing it, comprises cushioning means. The cushioning means comprises a soft, comfortable material; in this embodiment polyester velvet. In other embodiments, the inner surface of the belt body itself comprises such a material.

In other embodiments, the cushioning means and/or the inner surface of the belt body 2 may comprise a material, for example PU-treated nylon, having a high friction coefficient against the body of the person wearing the belt.

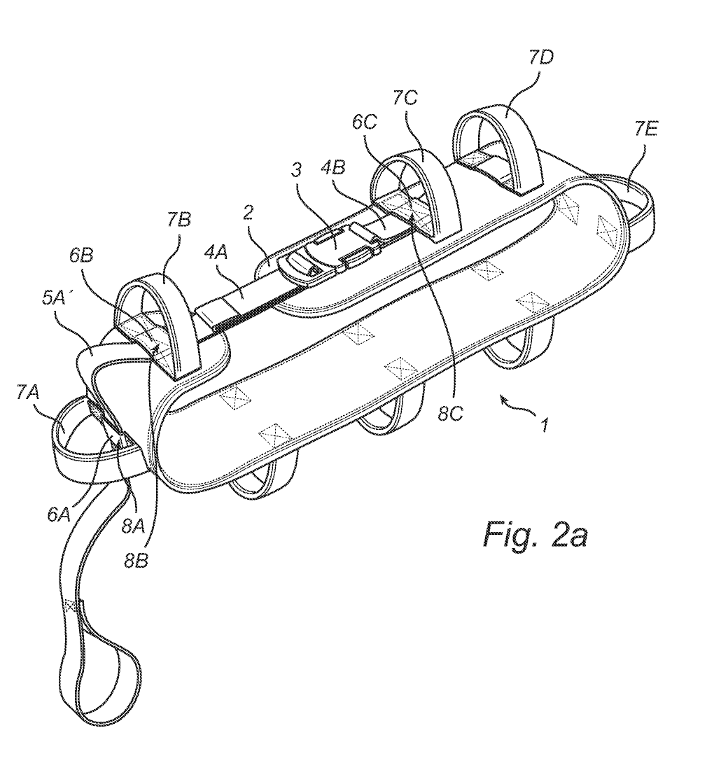

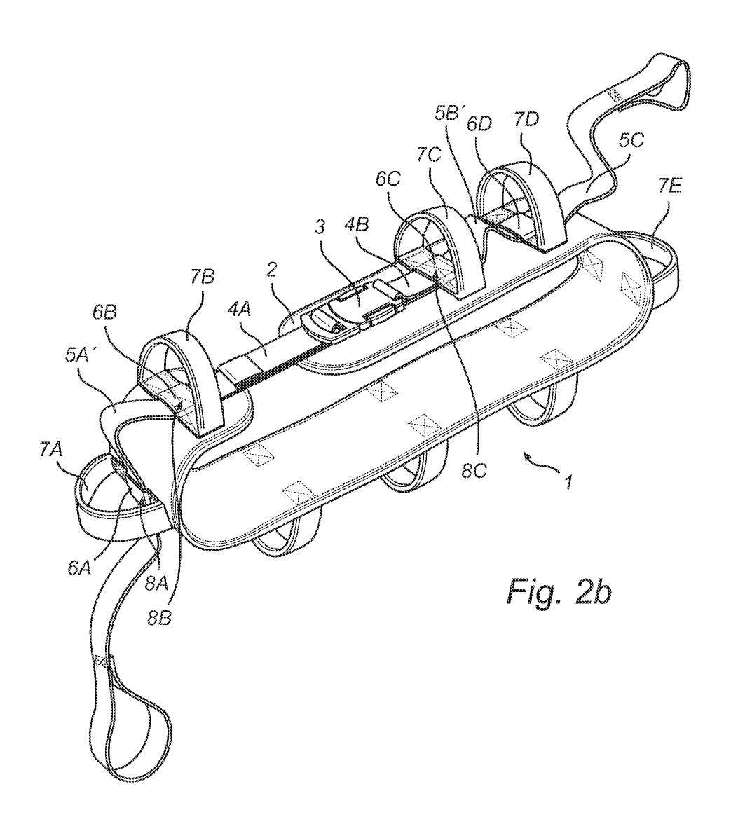

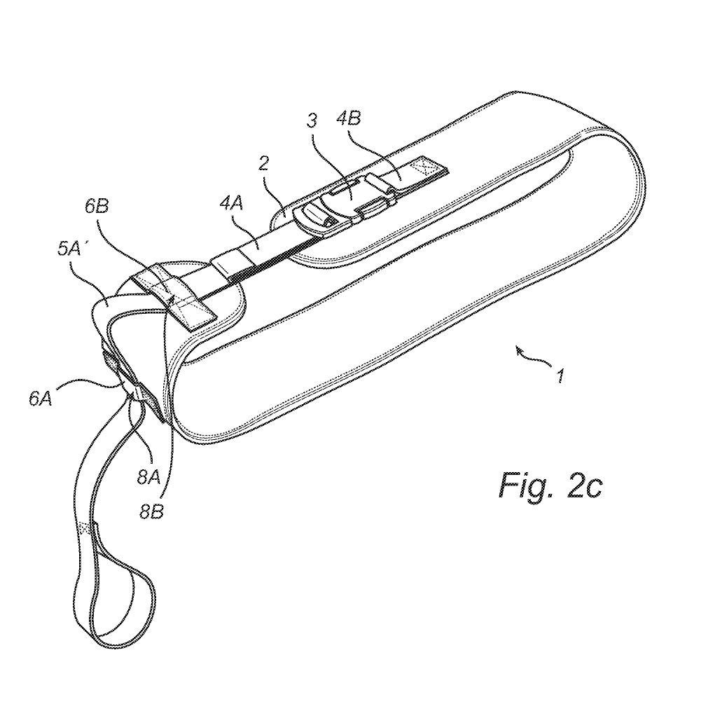

In FIG. 2a, a transfer belt according to the invention is illustrated wherein the transfer belt comprises a belt body 2, a loop 6A and a handle means 5A′. The loop 6A is attached to the belt body at a first longitudinal position 8A in a longitudinal direction of said belt body. The handle means 5A′ is slidably arranged through said loop 6A and is attached to the belt body 2, via a first attachement point 6B, at a second longitudinal position 8B in the longitudinal direction, wherein the second longitudinal position is different or spaced apart from said first longitudinal position in said longitudinal direction. Thereby, when subjecting the loose end, i.e. the unattached end, of the handle means 5a′ to an external force, the handle means is forced through the loop thereby, in the longitudinal direction, forcing the first and second longitudinal positions together or towards each other in order to tighten the transfer belt 1 against the waist of the person wearing it. In other words, when the first and second longitudinal positions are forced together the tightening length is decreased thereby squeezing the belt body together in the longitudinal direction in order to induce a tightening effect of the transfer belt. Put differently, the transfer belt in FIG. 2a comprises a belt body and a thereto attached tightening arrangement. The tightening arrangement comprises the loop 6A and the handle means 5A′ which is slidably arranged in the loop. The loop is attached to the belt body at the first position or a at loop position 8a; whereas the handle means 5A′ is attached to the belt body at the second position or at a handle means position 8B. The handle means position is spaced apart or different from the loop position in the longitudinal direction of the belt such that, when subjecting the unattached end of the handle means to an external force, the part of the handle means between the handle means position and the loop position is forced through the loop. Thereby the loop position and the handle means position is forced together or towards each other in the longitudindal direction in order to tighten the transfer belt against the waist of said person. It is understood that different tightening effect can be obtained by changing the distance between the loop position and handle means position, i.e. the tightening length.

A number of stationary handles 7A-E are attached to an outer surface of the belt body 2, extending in a transversal direction, i.e. perpendicular to the longitudinal direction, of the belt body. The outer surface of the transfer belt in this context is the surface facing away from the person (not shown) wearing the belt. The stationary handles have curved shapes from the outer surface of the transfer belt providing graspable spaces defined by the belt body and the handle body.

FIG. 2b illustrates a transfer belt that comprises two tightening arrangements. The transfer belt comprises a belt body 2, two loops 6A, 6D and two handle means 5A′, 5B′, 5C′. In addition to a first tightening arrangement as shown in FIG. 2A, the transfer belt in FIG. 2b further comprises an additional loop 6D which is attached to the belt body at a first longitudinal position 8D in a longitudinal direction of said belt body. The additional handle means 5B, 5C′ is slidably arranged through said loop 6D and is attached to the belt body 2, via a second attachement point 6C, at a second longitudinal position 8D in the longitudinal direction, wherein the second longitudinal position is different or spaced apart from said first longitudinal position in said longitudinal direction. Thereby, when subjecting the loose end, i.e. the unattached end, of the additional handle means 5B′, 5C′ to an external force, the handle means is forced through the loop thereby, in the longitudinal direction, forcing the first and second longitudinal positions together or towards each other in order to tighten the transfer belt 1 against the waist of the person wearing it. The part 5B′ of the handle means between the loop position 8D and the handle means position 8C is forced through the loop 6D. Thus, when the first and second longitudinal positions are forced together the tightening length is decreased thereby squeezing the belt body together in the longitudinal direction in order to induce a tightening effect of the transfer belt.

A number of stationary handles 7A-E are attached to an outer surface of the belt body 2, extending in a transversal direction, i.e. perpendicular to the longitudinal direction, of the belt body. The outer surface of the transfer belt in this context is the surface facing away from the person (not shown) wearing the belt. The stationary handles have curved shapes from the outer surface of the transfer belt providing graspable spaces defined by the belt body and the handle body.

FIG. 2c illustrates a transfer belt with only one tightening arrangement. This transfer belt comprises a belt body 2, a loop 6A and a handle means 5A′. The loop 6A is attached to the belt body at a first longitudinal position 8A in a longitudinal direction of said belt body. The handle means 5A′ is slidably arranged through said loop 6A and is attached to the belt body 2, via a first attachement portion 6B, at a second longitudinal position 8B in the longitudinal direction, wherein the second longitudinal position is different or spaced apart from said first longitudinal position in said longitudinal direction. Thereby, when subjecting the loose end, i.e. the unattached end, of the handle means 5a′ to an external force, the handle means is forced through the loop thereby, in the longitudinal direction, forcing the first and second longitudinal positions together or towards each other in order to tighten the transfer belt 1 against the waist of the person wearing it. In other words, when the first and second longitudinal positions are forced together the tightening length is decreased thereby squeezing the belt body together in the longitudinal direction in order to induce a tightening effect of the transfer belt.

Although an exemplary embodiment of the present invention has been shown and described, it will be apparent to the person skilled in the art that a number of changes and modifications, or alterations of the invention as described herein may be made. Thus, it is to be understood that the above description of the invention and the accompanying drawing is to be regarded as a non-limiting example thereof and that the scope of the invention is defined in the appended patent claims.

1. A transfer belt for facilitating assisted transfer of a person, said transfer belt comprising:
a belt body;
a loop being attached to the belt body at a first longitudinal position in a longitudinal direction of said belt body; and
a handle being slidably arranged through said loop, said handle being attached to the belt body at a second longitudinal position in said longitudinal direction, wherein said second longitudinal position being, in said longitudinal direction, spaced apart from said first longitudinal position such that, when subjecting said handle to an external force, the handle is forced through the loop thereby longitudinally forcing the first and second longitudinal positions together in order to tighten the transfer belt against the waist of said person.

2. The transfer belt according to claim 1, wherein said belt further comprises
at least one additional loop which is attached to the belt body at at least one additional first longitudinal position in the longitudinal direction of said belt body; and
at least one additional handle, wherein said at least one additional handle is slidably arranged through said at least one additional loop, wherein said at least one additional handle is attached to the belt body at at least one additional second longitudinal position in said longitudinal direction, wherein said at least one additional second longitudinal position(s) is, in said longitudinal direction, spaced apart from said at least one additional first longitudinal position such that, when subjecting said at least one additional handle to an external force, the at least one additional handle means is forced through the at least one additional loop thereby longitudinally forcing the at least one additional first and second longitudinal positions together in order to tighten the transfer belt against the waist of said person.

3. The transfer belt according to claim 1, wherein said loop comprises a loop body having a first loop end and a second loop end, wherein said first loop end and second loop end are attached to the belt body at said first longitudinal position such that said handle passes through said loop essentially at said first longitudinal position.

4. The transfer belt according to claim 1, wherein said handle is further attached to the belt body at a third longitudinal position in said longitudinal direction, wherein said third longitudinal position is spaced apart from said first longitudinal position and second longitudinal position thereby forming a handle attached to said belt body.

5. The transfer belt according to claim 4, wherein said handle loosely extends between said second longitudinal position and third longitudinal position, thereby resulting in a handle that is easily graspable.

6. The transfer belt according to claim 4, wherein said first longitudinal position is between said second longitudinal position and third longitudinal position in said longitudinal direction, thereby resulting in graspable handles at either side of said loop.

7. The transfer belt according to claim 4, wherein said transfer belt comprises at least two loops which are attached to the belt body at longitudinal positions in said longitudinal direction which are spaced apart from said second longitudinal position and third longitudinal position, wherein said handle is slidably arranged through said at least two loops.

8. The transfer belt according to claim 4, wherein said transfer belt further comprises at least one additional loop which is attached to the belt body at at least one additional longitudinal position in said longitudinal direction which is/are spaced apart from said second longitudinal position(s) and said third longitudinal position(s), wherein said at least one additional handle means is slidably arranged through said at least one additional loops.

9. The transfer belt according to claim 7, wherein said longitudinal positions of said at least two loops are between said second longitudinal position and third longitudinal position in said longitudinal direction.

10. The transfer belt according to claim 7, wherein said loops are evenly distributed over the longitudinal length of the belt body.

11. The transfer belt according to claim 1, wherein said transfer belt, at an inner surface facing said person wearing it, further comprises a cushioning device configured to provide comfort to said person wearing it.

12. The transfer belt according to claim 1, wherein said handle and said loop(s) are attached to an outer surface of said transfer belt facing away from said person wearing it.

13. The transfer belt according to claim 1, wherein said transfer belt further comprises a fastening device configured to releasably fasten said transfer belt around the waist of said person.

14. The transfer belt according to claim 1, wherein said transfer belt further comprises at least one stationary handle attached to said belt body.

15. The transfer belt according to claim 1, wherein said handle means is a strap, tape, line, rope, cord or lace.

16. The transfer belt according to claim 1, wherein said loop body is a strap, tape, line, rope, cord, band or lace.

17. The transfer belt according to claim 1, wherein said cushioning device and/or the inner surface of the belt body comprises a high friction material having a high friction coefficient, such as PU-treated nylon, whereby the transfer belt provides a high friction relative to the waist of the person wearing the belt.

18. The transfer belt according to claim 2, wherein said loop comprises a loop body having a first loop end and a second loop end, wherein said first loop end and second loop end are attached to the belt body at said first longitudinal position such that said handle passes through said loop essentially at said first longitudinal position.

19. The transfer belt according to claim 2, wherein said handle is further attached to the belt body at a third longitudinal position in said longitudinal direction, wherein said third longitudinal position is spaced apart from said first longitudinal position and second longitudinal position thereby forming a handle attached to said belt body.

20. The transfer belt according to claim 3, wherein said handle is further attached to the belt body at a third longitudinal position in said longitudinal direction, wherein said third longitudinal position is spaced apart from said first longitudinal position and second longitudinal position thereby forming a handle attached to said belt body.
